(19) United States
(12) Patent Application Publication
(10) Pub. No.: US 2012/0121771 A1
(43) Pub. Date: May 17, 2012

(54) QUICK HEAT-UP GAS INFRARED BURNER FOR AIR IMPINGEMENT OVENS

(75) Inventor: Douglas S. Jones, New Port Richey, FL (US)

(73) Assignee: LINCOLN FOODSERVICE PRODUCTS LLC

(21) Appl. No.: 13/296,666

(22) Filed: Nov. 15, 2011

Related U.S. Application Data
(60) Provisional application No. 61/413,956, filed on Nov. 15, 2010.

(51) Int. Cl. F23D 14/12; F24C 3/08; A23L 1/01; F24C 15/00

(52) U.S. Cl. 426/243; 126/15 R; 126/39 R; 431/328

(57) ABSTRACT

An oven that uses both impinging air ducts and infrared burners to heat food products is provided. Heating and cooking with both types of burners leads to a significantly improved efficiency over currently available systems. The infrared burner comprises a matrix of metal fibers that allows for the combustion flame to remain stable even when subject to the currents of nearby impinging air ducts within the oven cavity.

### CROSS-REFERENCE TO RELATED APPLICATIONS

The present disclosure claims the benefit of U.S. Provisional Patent Application No. 61/413,956, filed on Nov. 15, 2010.

### BACKGROUND OF THE DISCLOSURE

1. Field of the Disclosure

The present disclosure relates to burners that are used in air impingement ovens. More particularly, the present disclosure relates to gas infrared burners that are used in conjunction with high velocity heated air to cook food products in an oven.

2. Description of the Related Art

Current commercial conveyor ovens use heated air forcefully directed at food products placed on the conveyor belt from both top and bottom to cook or heat the food product. Some ovens use infrared heaters to heat the product without high velocity air movement. Both methods of heating are effective. However, air impingement and infrared cooking give different tastes and textures to the food products being cooked. With infrared burners, high velocity air is typically not used, due to the effect of high velocity air interfering with the infrared burner's ability to produce a quality flame and/or infrared energy. Thus, there is a need to improve the efficiency of conveyor ovens while addressing these disadvantages.

### SUMMARY OF THE DISCLOSURE

The present disclosure provides gas infrared burner assemblies that are designed for use in an oven environment with high velocity air circulation. The burner assemblies comprise a burner surface made of layers or a matrix of small metal fibers. Combustion gases are fed to the burner surface and ignited, which allows the metal fibers to heat to infrared intensities.

Thus, in one embodiment, the present disclosure provides an oven for heating food products, comprising an interior cavity having a longitudinal axis, a conveyor for carrying the food products along the longitudinal axis of the interior cavity, an impinging air duct that blows heated air onto the food products carried by the conveyor, and an infrared burner comprising a burner surface facing the food products on the conveyor. When the burner surface is heated, it heats the food products on the conveyor.

In another embodiment, the present disclosure provides an infrared burner. The infrared burner comprises a burner surface comprising a porous matrix of metal fibers, a plenum connected to the burner surface, an inlet pipe in fluid communication with the plenum, wherein an air-gas mixture is introduced to the plenum through the inlet pipe, and an igniter, wherein the igniter ignites the air-gas mixture so that the ignited air-gas mixture surface heats the burner surface.

In another embodiment, the present disclosure provides a method of cooking a food product within an oven. The method comprises the steps of passing the food product through an internal cavity of the oven, blowing heated convection air currents through an impinging air duct onto the food product, wherein the air impinging air duct is within the internal cavity, and simultaneously with the blowing step, heating the food product with an infrared burner, wherein the infrared burner is within the internal cavity.

### BRIEF DESCRIPTION OF THE DRAWINGS

FIG. 1 shows a perspective view of a burner assembly of the present disclosure;

FIG. 2 shows a side plan view of the burner assembly of FIG. 1;

FIG. 3 shows an exploded view of the burner assembly of FIG. 1; and

FIG. 4 shows a side plan view of a conveyor oven utilizing the burner assembly of FIG. 1 locating the IR burners in one of many possible locations within the oven cavity.

### DETAILED DESCRIPTION OF THE INVENTION

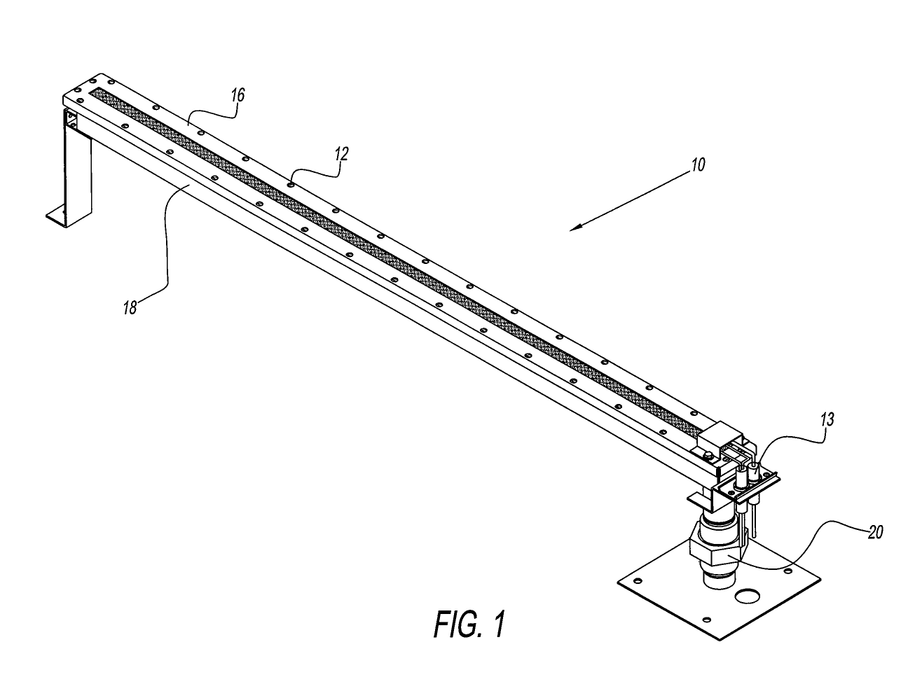

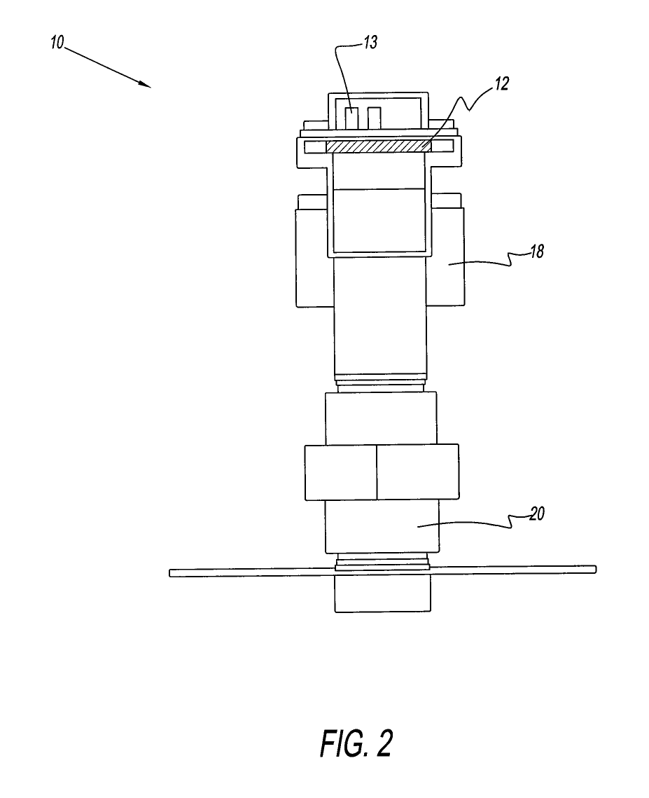

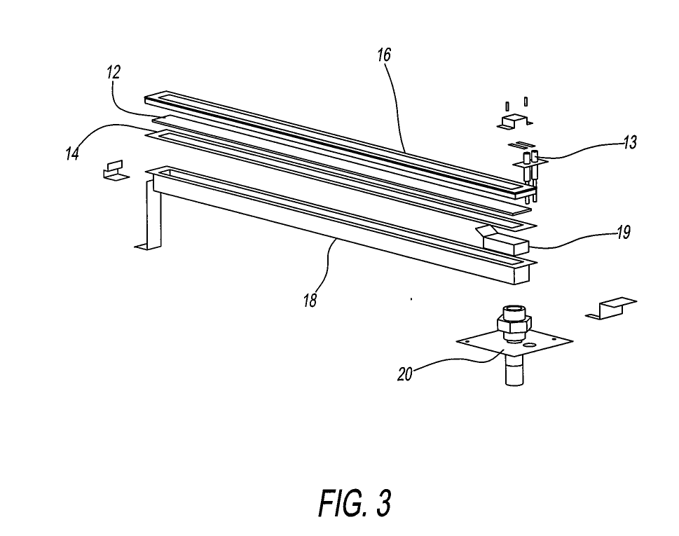

Referring to FIGS. 1-3, burner assembly 10 is shown. Burner assembly 10 comprises burner surface 12, igniter 13, mounting plate 14, clamping frame 16, plenum 18, and baffle 19. A mixture of air and combustible gas is fed from pipe 20 into plenum 18. Baffle 19 can assist with the even distribution of the air and gas mixture through plenum 18. From there, the air and gas mixture is forced up through burner surface 12, which is porous, and is ignited by igniter 13.

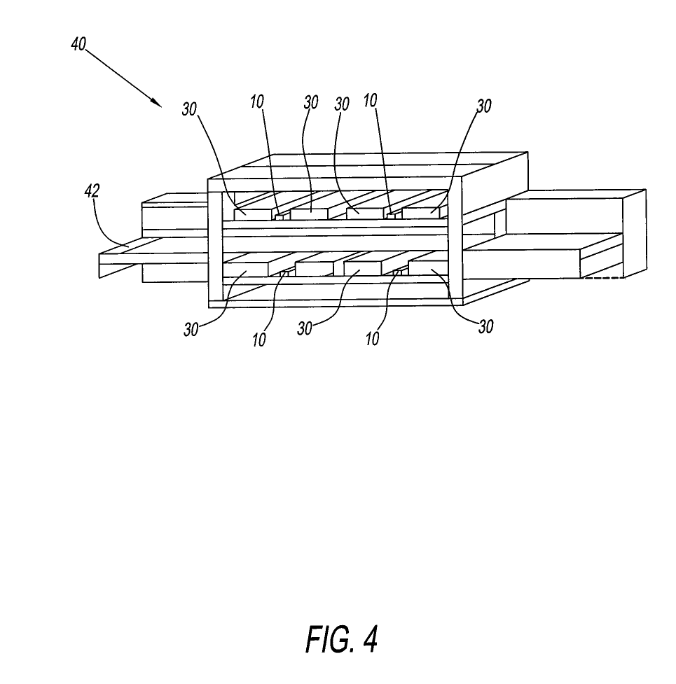

The design of burner assembly 10 allows it to be used in conjunction with impinging air ducts 30 in a conveyor oven 40, as shown in FIG. 4. Burner assembly 10 heats a food product passing through oven 40 on conveyor 42. There can be one or more burner assemblies 10 in an oven, on either side of conveyor 42, and oven 40 can have one or more impinging air ducts 30. Burner assemblies 10 can be placed in many possible locations within the oven cavity. Impinging air duct 30 delivers heated air to conveyor 42, and any food product thereon, though an air plenum that can have one or more dispensing orifices (not shown). As discussed in greater detail below, burner assembly 10 can be used right alongside an impinging air duct 30, without any adverse effects. The combined usage of infrared burner assemblies 10 and convection currents of heated air from ducts 30 presents increased flexibility, different food textures, and increased cooking speeds for oven 40, which was previously not thought possible. Depending on the food items being cooked, any number of burner assemblies 10 may be used to impart the food quality and texture desired.

Burner surface 12 is a layer or matrix of small metal fibers. Combustion takes place within the fiber matrix, and the flame is retained therein. As a result, burner assembly 10 provides combustion heat and infrared radiation to the oven environment, but is not subject to the disadvantages that typical infrared burners face when they are subjected to high velocity air flow. Burner surface 12 maintains the combustion flames within the matrix of small metal fibers, which allows the metal fibers to reach infrared intensities. Heat provided by the combustion process is forcibly directed towards the oven conveyor and the infrared energy provided by the heating of the metal fibers of the burner surface 12 enhances the cooking process. Examples of suitable products for the matrix of metal fibers in burner surface 12 include the D-Mat™, G-Mat™, and GFC-1™ fiber mats available from Micron Fiber-Tech, of Debary, Fla.

It was previously not thought possible to achieve all of these advantages within the same oven. Typically, high velocity air from the impingement jets blowing onto an infrared burner surface would blow out the flame on the infrared burners and/or disturb or blow the flame off the infrared burner, rendering it ineffective. In some previous models, infrared burners were designed with air shields placed over the burner surface to protect them from the convection currents of adjacent air ducts. The shields, however, would be cooled off by the convection air flow, and/or never reach the infrared burner intensity, which dramatically reduced the efficiency of the infrared burner. Again, the present disclosure overcomes these problems.

Burner assemblies 10 are designed to ignite and come up to infrared conditions in a short time (i.e., less than forty-five seconds) so that they can be turned off when not needed for energy conservation. Burner assemblies 10 can be turned on just prior to loading product on the conveyor 42, and by the time the product reaches the area where the infrared energy is needed, burner assemblies 10 are operating with full infrared intensity. This provides a significant savings in energy consumption.

The burner has been developed to be able to handle high velocity air directed at the burner surface and still achieve a high intensity infrared emission. The burner surface construction is critical to achieving high surface temperatures when subject to air being blown directly onto the burner surface. Ceramic tile burners, for example, cannot maintain surface temperature under these conditions. A burner surface 12 made of layers or a matrix of metal fibers that allow combustion and retain the flame within the outer layers of the material is required to achieve operation under the conditions found within an impingement oven.

The air gas mixture that is supplied through pipe 20 into plenum 18 provides additional convection heating within oven 40, as the air gas mixture will pass through burner surface 12, and into the cavity of oven 40. Furthermore, without being bound by theory, it is believed that the air gas mixture coming up through burner surface 12 provides enough pressure to ward off the convection air currents circulated by air ducts 30. This pressure exiting burner surface 12 may prevent the convection air currents from blowing out the combustion flame within burner surface 12. The physical characteristics (e.g., dimensions, porosity) of burner surface 12, as well as the size of plenum 18, and flow rate of the air gas mixture, all need to be adjusted to ensure that proper combustion occurs within burner surface 12, and still prevents the convention currents from duct 30 from adversely affecting the combustion within burner surface 12.

While the instant disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. An oven for cooking food products, comprising:
an interior cavity having a longitudinal axis;
a conveyor for carrying the food products along said longitudinal axis of said interior cavity;
an impinging air duct that blows heated air onto the food products carried by said conveyor; and
an infrared burner comprising a burner surface facing the food products on the conveyor, so that when said burner surface is heated, said burner surface heats the food products on the conveyor.

2. The oven of claim 1, wherein said infrared burner further comprises:
a plenum connected to said burner surface;
an inlet pipe in fluid communication with said plenum, wherein an air-gas mixture is introduced to said plenum through said inlet pipe; and
an igniter, wherein said igniter ignites said air-gas mixture so that the ignited air-gas mixture surface heats said burner surface,
wherein said burner surface comprises a porous matrix of metal fibers.

3. The oven of claim 1, wherein said infrared burner further comprises a baffle within said plenum, to assist with the even distribution of said air-gas mixture within said plenum.

4. The oven of claim 1, wherein said impinging air duct is a plurality of air impinging ducts, and said infrared burner is a plurality of infrared burners.

5. The oven of claim 4, wherein at least one of said plurality of infrared burners is located adjacent to at least one of said plurality of air impinging ducts.

6. The oven of claim 4, wherein conveyor has a top side and a bottom side, wherein at least one of said plurality of air impinging ducts and at least one of said plurality of infrared burners is located on said top side of said conveyor, and at least one of said plurality of air impinging ducts and at least one of said plurality of infrared burners is located on said bottom side of said conveyor.

7. An infrared burner, comprising:
a burner surface comprising a porous matrix of metal fibers;
a plenum connected to said burner surface;
an inlet pipe in fluid communication with said plenum, wherein an air-gas mixture is introduced to said plenum through said inlet pipe; and
an igniter, wherein said igniter ignites said air-gas mixture so that the ignited air-gas mixture surface heats said burner surface.

8. The infrared burner of claim 7, further comprising a baffle within said plenum, to assist with the even distribution of said air-gas mixture within said plenum.

9. A method of cooking a food product within an oven, comprising the steps of:
passing the food product through an internal cavity of the oven;
blowing heated air through an impinging air duct onto the food product, wherein said air impinging air duct is within said internal cavity; and
simultaneously with said blowing step, heating the food product with an infrared burner, wherein said infrared burner is within said internal cavity.

10. The method of claim 9, wherein said infrared burner comprises:
a burner surface comprising a porous matrix of metal fibers;
a plenum connected to said burner surface;
an inlet pipe in fluid communication with said plenum; and
an igniter,
the method further comprising the steps of:
introducing an air-gas mixture to said plenum through said inlet pipe; and
igniting said air-gas mixture so that said burner surface is heated, and said burner surface heats the food product.
